(19) United States
(12) Patent Application Publication
(10) Pub. No.: US 2026/0009951 A1
(43) Pub. Date: Jan. 8, 2026

(54) OPTICAL FIBER CONNECTOR

(71) Applicant: HYC Co., Ltd, Guangdong (CN)

(72) Inventors: Lei ZHU, Guangdong (CN); Haibo YANG, Guangdong (CN); Chenglong YANG, Guangdong (CN); Yaobo YANG, Guangdong (CN); Shengchu LIU, Guangdong (CN)

(21) Appl. No.: 18/900,558

(22) Filed: Sep. 27, 2024

(30) Foreign Application Priority Data
Jul. 5, 2024 (CN) 202421579481.1

(51) Int. Cl. G02B 6/38

(52) U.S. Cl. CPC G02B 6/3831; G02B 6/3825

(57) ABSTRACT

An optical fiber connector includes a connector body, an outer frame sleeve and a tail frame sleeve. An inner core configured to be connected to a fitting member is disposed at a front end of the connector body; the outer frame sleeve is slidably sleeved on the connector body; the tail frame sleeve includes a grip portion and connecting portions configured to be connected to the outer frame sleeve, where the connecting portions extend forwards from the grip portion, and the grip portion is slidably sleeved on the connector body; the connecting portions are configured to apply force in a direction away from the fitting member to the outer frame sleeve when the tail frame sleeve is pulled in a direction away from the inner core.

### CROSS-REFERENCE TO RELATED APPLICATION

This application claims priority to Chinese Patent Application No. 202421579481.1 filed Jul. 5, 2024, the disclosure of which is incorporated herein by reference in its entirety.

### TECHNICAL FIELD

The present disclosure relates to the technical field of optical fiber devices, for example, to an optical fiber connector.

### BACKGROUND

With the rapid development of information technology, there is an increasing demand for optical communication products worldwide. The optical communication industry has gradually become one of the most important industries in the process of informatization. In optical transmission systems, optical fiber connectors become important components for connecting optical fibers. During the using of an optical fiber connector, a connecting body of the optical fiber connector is plugged into an adapter to be locked with the adapter, and the lock between the connector body and the adapter can be released by pulling an outer frame sleeve sleeved on the connector body backwards.

When optical fiber connectors on the adapter are densely arranged, the distance between optical fiber connectors is relatively small, which is inconvenient for inserting fingers and pulling outer frame sleeves backwards. In view of this, pull rods are disposed on some optical fiber connectors. A pull rod is disposed on the outer side of the connector body, an end of the pull rod is connected to the outer frame sleeve, and the other end of the pull rod can be pulled so that the outer frame sleeve is pulled and then moves backwards, so the operation is convenient. However, a gap is formed between the pull rod and the connector body, thus the optical cables drawn from adjacent optical fiber connectors are easily jammed in the gap and become tangled, and as a result, optical cables are difficult to be managed and are easily to be snapped.

### SUMMARY

The present disclosure provides an optical fiber connector to solve the problem in the related art that optical fibers are easily jammed in the gap between pull rods and connector bodies, and thus optical cables are difficult to be managed and are even snapped.

The optical fiber connector includes a connector body, where an inner core configured to be connected to a fitting member is disposed at a front end of the connector body.

The optical fiber connector further includes an outer frame sleeve slidably sleeved on the connector body.

The optical fiber connector further includes a tail frame sleeve. The tail frame sleeve includes a grip portion and a connecting portion configured to be connected to the outer frame sleeve, where the connecting portion extends forwards from the grip portion, and the grip portion is slidably sleeved on the connector body; the connecting portion is configured to apply force in a direction away from the fitting member to the outer frame sleeve when the tail frame sleeve is pulled in a direction away from the inner core.

In some embodiments, the connecting portion includes a connecting arm extending forwards from the grip portion and a hook portion at a front end of the connecting arm, an abutting portion is provided on the outer frame sleeve, and the abutting portion abuts the hook portion and is located on a rear side of the hook portion.

In some embodiments, the connecting arm is an elastic arm, and the hook portion protrudes outwards from the connecting arm in a direction perpendicular to an extension direction of the connecting arm; an abutting groove is provided on the outer frame sleeve, a rear side wall of an abutting groove of the abutting grooves forms at least part of the abutting portion, and the hook portion is located in the abutting groove.

In some embodiments, a first stop protrusion radially protrudes from the outer frame sleeve, and the rear side wall of the abutting groove and part of a front side wall of the first stop protrusion form the abutting portion.

In some embodiments, a guide portion is provided on the hook portion and is configured to guide the hook portion into the abutting groove, and a side of the guide portion extends forwards and tilts towards an axis of the outer frame sleeve.

In some embodiments, a sliding groove is provided on an outer periphery of the connector body, a reinforcement protrusion is provided at an end of the connecting arm close to the grip portion, and the reinforcement protrusion is inserted through the sliding groove.

In some embodiments, a sliding groove is provided on an outer periphery of the connector body, and the connecting portion is slidably inserted through the sliding grooves; and/or, at least four connecting portions are provided, and the at least four connecting portions are disposed around an axis of the connector body.

In some embodiments, a pull protrusion radially protrudes from the tail frame sleeve.

In some embodiments, a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

In some embodiments, the connector body includes a front frame sleeve, a middle frame sleeve and a crimp ring, and the front frame sleeve, the middle frame sleeve and the crimp ring are sequentially connected.

The inner core is disposed inside the front frame sleeve.

Alternatively, the tail frame sleeve is sleeved on the crimp ring and has a clearance fit with the crimp ring.

### BRIEF DESCRIPTION OF DRAWINGS

FIG. 1 is a structural view of an optical fiber connector according to an embodiment of the present disclosure;

FIG. 2 is an enlarged view of part A in FIG. 1;

FIG. 3 is an exploded view of an optical fiber connector according to an embodiment of the present disclosure;

FIG. 4 is an enlarged view part B in FIG. 3;

FIG. 5 is a sectional view of an optical fiber connector according to an embodiment of the present disclosure; and

FIG. 6 is a structural view of multiple optical fiber connectors and multiple adapters according to an embodiment of the present disclosure.

Reference list

| | |
|---|---|
| 10 | optical fiber connector |
| 20 | adapter |
| 100 | connector body |
| 110 | front frame sleeve |
| 120 | middle frame sleeve |
| 121 | sliding groove |
| 122 | second stop protrusion |
| 130 | crimp ring |
| 140 | inner core |
| 141 | docking portion |
| 200 | outer frame sleeve |
| 210 | abutting portion |
| 220 | abutting groove |
| 230 | first stop protrusion |
| 300 | tail frame sleeve |
| 310 | grip portion |
| 311 | pull protrusion |
| 320 | connecting portion |
| 321 | connecting arm |
| 322 | hook portion |
| 3221 | guide portion |
| 323 | reinforcement protrusion |
| 340 | pushing portion |

### DETAILED DESCRIPTION

Technical solutions of the present disclosure are clearly and completely described below in conjunction with the drawings. Apparently, embodiments described herein are part, not all, of the embodiments of the present disclosure. Based on the embodiments of the present disclosure, all other embodiments obtained by those of ordinary skill in the art are within the scope of the present disclosure on the premise that no creative work is done.

In the description of the present disclosure, it is to be noted that orientations or position relations indicated by terms such as “center”, “upper”, “lower”, “left”, “right”, “vertical”, “horizontal”, “in” and “out” are based on orientations or position relations shown in the drawings. These orientations or position relations are intended only to facilitate and simplify description of the present disclosure and not to indicate or imply that a device or element referred to must have such specific orientations or must be configured or operated in such specific orientations. Thus, these orientations or position relations are not to be construed as limiting the present disclosure. In addition, terms such as “first” and “second” are used only for the purpose of description and are not to be construed as indicating or implying relative importance. Terms “first position” and “second position” are two different positions. Moreover, when a first feature is described as “on”, “above” or “over” a second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

In the description of the present disclosure, it is to be noted that, unless otherwise expressly specified and limited, the term “mounting”, “connected to each other” or “connected” is to be construed in a broad sense, for example, as securely connected, detachably connected or integrally connected; mechanically connected or electrically connected; directly connected to each other or indirectly connected to each other via an intermediary; or internally connected between two elements. For those of ordinary skill in the art, specific meanings of the preceding terms in the present disclosure may be understood based on specific situations.

The embodiments of the present disclosure are described in detail hereinafter. Examples of the embodiments are illustrated in the drawings, where the same or similar reference numerals indicate the same or similar elements or elements having the same or similar functions. The embodiments described below with reference to the drawings are illustrative, only for explaining the present disclosure, and not to be construed as limiting the present disclosure.

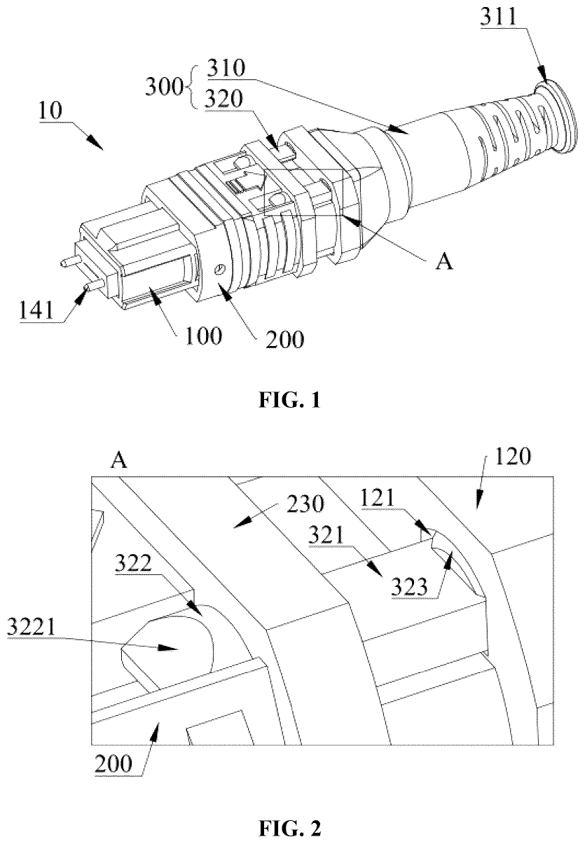

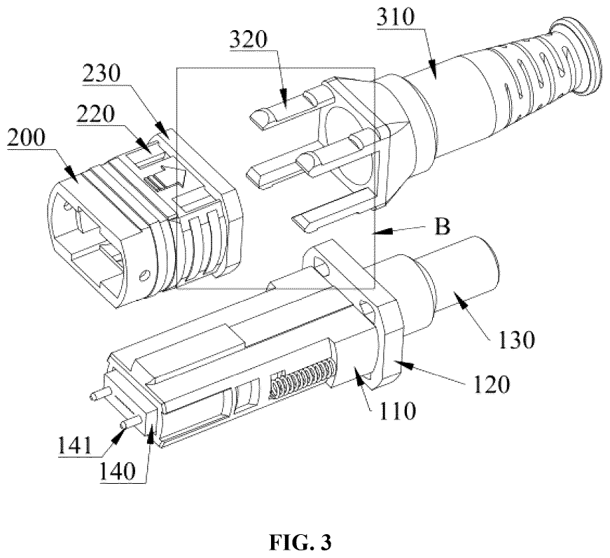

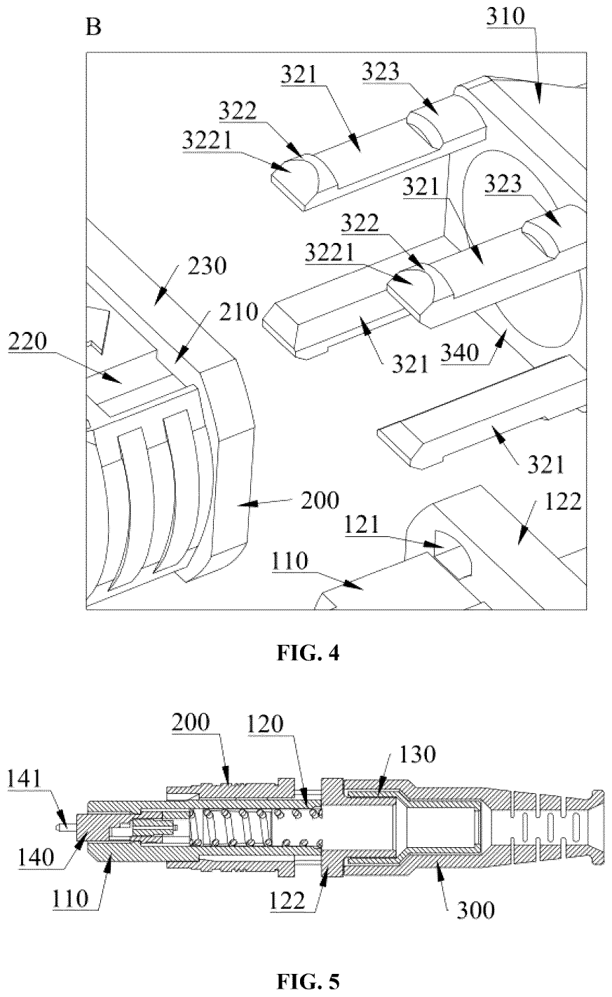

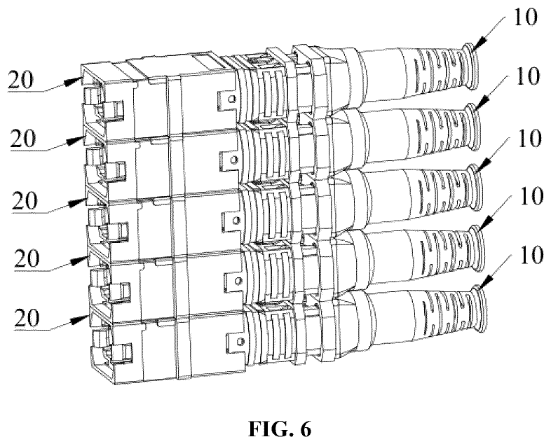

As shown in FIG. 1 to FIG. 6, an embodiment provides an optical fiber connector 10 configured to be connected to a fitting member, where the fitting member includes an adapter 20. The optical fiber connector 10 includes a connector body 100 and an outer frame sleeve 200. The connector body 100 can be locked with the adapter 20, an inner core 140 configured to be docked with the adapter 20 is disposed at a front end of the connector body 100, and docking portions 141 are disposed at a front end of the inner core 140. When the connector body 100 is inserted into the adapter 20, the inner core 140 remains fixed relative to the adapter 20, facilitating communication connection with other components. The outer frame sleeve 200 is slidably sleeved on the connector body 100. Pulling the outer frame cover 200 backwards can unlock the optical fiber connector 10 and adapter 20 so that the optical fiber connector 10 and adapter 20 can be separated.

In some embodiments, the optical fiber connector 10 further includes a tail frame sleeve 300. The tail frame sleeve 300 includes a grip portion 310 and connecting portions 320 configured to be connected to the outer frame sleeve 200. The connecting portions 320 extend forwards from the grip portion 310, and the grip portion 310 is slidably sleeved on the connector body 100. The connecting portions 320 are configured to apply force in a direction away from the adapter 20 to the outer frame sleeve 200 when the tail frame sleeve 300 is pulled in a direction away from the inner core 140.

In this setting, when the tail frame sleeve 300 is pulled backwards, the connecting portions 320 can apply force in a direction away from the adapter 20 to the outer frame sleeve 200, thereby driving the outer frame sleeve 200 to move backwards, and then unlocking the connector body 100 and the adapter 20. When multiple optical fiber connectors 10 are mounted in parallel on the adapter 20, tail frame sleeves 300 can be directly pulled backwards so that outer frame sleeves 200 move backwards, improving the convenience of the operation. In this manner, a pull rod structure is omitted, that is, no gap exists between the pull rod and the connector, which avoids the problem of optical cables jamming, facilitates the management of optical cables, and reduces the probability of optical cables being broken at the connector body 100.

To smoothly pull the tail frame sleeve 300 backwards, a pull protrusion 311 radially protrudes from the tail frame sleeve 300. When the tail frame sleeve 300 is manually pulled backwards, the pull protrusion 311 provides a point of application of force, allowing the tail frame sleeve 300 to smoothly move backwards relative to the connector body 100. The pull protrusion 311 is provided at a rear end of the grip portion 310.

Sliding grooves 121 are provided on an outer periphery of the connector body 100; and the connecting portions 320 are slidably inserted through the sliding grooves 121. On the one hand, this setting is conducive to standardizing the sliding routes of the connecting portions 320 and thus avoiding the tail frame sleeve 300 rotating around an axis; on the other hand, this setting is conducive to achieving accurate alignment between the tail frame sleeve 300 and the connector body 100 during mounting.

Further, at least four connecting portions 320 are provided, and the at least four connecting portions 320 are disposed around an axis of the connector body 100. In some embodiments, the outer cross-sectional profile of the tail frame sleeve 300 at the connecting portions 320 is a rectangle and four connecting portions 320 are disposed at four corners of the rectangle respectively so that the outer frame sleeve 200 is uniformly stressed and thus can smoothly move backwards.

To apply force to the outer frame sleeve 200 through the connecting portions 320, in some embodiments, a connecting portion 320 includes a connecting arm 321 extending forwards from the grip portion 310 and a hook portion 322 at a front end of the connecting arm 321. Abutting portions 210 are provided on the outer frame sleeve 200, and an abutting portion 210 abuts the hook portion 322 and is located on a rear side of the hook portion 322.

For ease of assembly, in some embodiments, the connecting arm 321 is an elastic arm, and the hook portion 322 protrudes outwards from the connecting arm 321 in a direction perpendicular to an extension direction of the connecting arm 321. Abutting grooves 220 are provided on the outer frame sleeve 200, and a rear side wall of an abutting groove 220 forms at least part of the abutting portion 210. The hook portion 322 is located in the abutting groove 220. In the embodiment, the hook portion 322 is integrally formed with the connecting arm 321. During assembly, the elastic arm bends and rebounds to allow the hook portion 322 to enter the abutting groove 220 from the outside of the abutting groove 220 and thus to ensure the reliability of abutting between the hook portion 322 and the abutting portion 210.

In the embodiment where the connecting arm 321 is a non-elastic arm, the hook portion 322 is detachably connected to the connecting arm 321 to facilitate the smooth insertion of the hook portion 322 into the abutting groove 220.

On the premise of the certain thickness of the outer frame sleeve 200, to increase the area of the abutting portion 210, in some embodiments, a first stop protrusion 230 radially protrudes from the outer frame sleeve 200, and the rear side wall of the abutting groove 220 and part of a front side wall of the first stop protrusion 230 form the abutting portion 210. On the one hand, the first stop protrusion 230 increases the area of the abutting portion 210, improves the tensile strength of the outer frame sleeve 200, and reduces the probability of damage to the rear side wall of the abutting groove 220 during the backward pulling process; on the other hand, the first stop protrusion 230 can also provide a point of application of force for fingers when the fingers pull the outer frame sleeve 200 backwards.

To facilitate the entering of the hook portion 322 into the abutting groove 220, in some embodiments, a guide portion 3221 is provided on the hook portion 322 and is configured to guide the hook portion 322 into the abutting groove 220. The guide portion 3221 is an inclined surface and extends forwards and tilts towards the axis of the outer frame sleeve 200.

As shown in FIG. 2, in some embodiments, a reinforcement protrusion 323 is provided at an end of the connecting arm 321 close to the grip portion 310, and the reinforcement protrusion 323 is inserted through a sliding groove 121. The cross-sectional profile of the connecting arm 321 at the reinforcement protrusion 323 is the same as the profile of the sliding groove 121. The reinforcement protrusion 323 not only enhances the strength of the connecting arm 321 at an end portion, but also prevents the connecting arm 321 from shaking in the sliding groove 121, improving the reliability of the connection between the hook portion 322 and the abutting portion 210.

In other embodiments, the connection between the connecting portion 320 and the outer frame sleeve 200 may also be achieved through bonding or welding, as long as it is ensured that the connecting portion 320 can drive the outer frame sleeve 200 to move backwards when the tail frame sleeve 300 is pulled backwards.

To improve the convenience of mounting the optical fiber connector 10 on the adapter 20, in some embodiments, a second stop protrusion 122 protrudes from the outer periphery of the connector body 100. A pushing portion 340 is provided on the tail frame sleeve 300. The pushing portion 340 is configured to apply force in a direction close to the adapter 20 to the second stop protrusion 122 when the tail frame sleeve 300 is pushed in a direction close to the inner core 140, thereby driving the connector body 100 to move in a direction close to the adapter 20, and ultimately enabling the connector body 100 to be inserted into the adapter 20 and to be locked.

In some embodiments, the sliding groove 121 penetrates the second stop protrusion 122 and forms a through-hole structure. During mounting, the connecting portion 320 passes through the sliding groove 121 to send the hook portion 322 at a front end of the connecting portion 320 into the abutting groove 220.

As shown in FIG. 5, the connector body 100 includes a front frame sleeve 110, a middle frame sleeve 120 and a crimp ring 130. The front frame sleeve 110, the middle frame sleeve 120 and the crimp ring 130 are sequentially connected. The inner core 140 is disposed inside the front frame sleeve 110. The tail frame sleeve 300 is sleeved on the crimp ring 130 and has a clearance fit with the crimp ring 130 so that the tail frame sleeve 300 and the crimp ring 130 can slide relative to each other. The front frame sleeve 110 is engaged with the middle frame sleeve 120, the middle frame sleeve 120 is threaded to the crimp ring 130, and the front frame sleeve 110, the middle frame sleeve 120 and the crimp ring 130 are secured relative to each other in a front-to-rear direction. In the embodiment, the second stop protrusion 122 is provided on a periphery of the middle frame sleeve 120.

During mounting, the middle frame sleeve 120 is connected to the crimp ring 130, then the tail frame sleeve 300 is sleeved on the crimp ring 130, the connecting portions 320 pass through the sliding grooves 121, the outer frame sleeve 200 is sleeved on the connecting portions 320, the hook portions 322 are located in the abutting grooves 220, and finally, the front frame sleeve 110 on which the inner core 140 is mounted is connected to the middle frame sleeve 120.

In the embodiment, the arrangement direction of the front frame sleeve 110, the middle frame sleeve 120 and the crimp ring 130 is taken as the reference. The direction from the front frame sleeve 110 to the crimp ring 130 is the rear direction, and the direction from the crimp ring 130 to the front frame sleeve 110 is the front direction.

Apparently, the preceding embodiments of the present disclosure are merely illustrative examples of the present utility and are not intended to limit implementations of the present disclosure. Those of ordinary skill in the art can make changes or variations in other different forms based on the preceding description. All embodiments cannot be and do not need to be exhausted herein.

What is claimed is:

1. An optical fiber connector, comprising
a connector body, wherein an inner core configured to be connected to a fitting member is disposed at a front end of the connector body;
an outer frame sleeve, slidably sleeved on the connector body; and
a tail frame sleeve, comprising a grip portion and a connecting portion configured to be connected to the outer frame sleeve, wherein the connecting portion extends forwards from the grip portion, and the grip portion is slidably sleeved on the connector body; the connecting portion is configured to apply force in a direction away from the fitting member to the outer frame sleeve when the tail frame sleeve is pulled in a direction away from the inner core.

2. The optical fiber connector according to claim 1, wherein the connecting portion comprises a connecting arm extending forwards from the grip portion and a hook portion at a front end of the connecting arm, an abutting portion is provided on the outer frame sleeve, and the abutting portion abuts the hook portion and is located on a rear side of the hook portion.

3. The optical fiber connector according to claim 2, wherein the connecting arm is an elastic arm, and the hook portion protrudes outwards from the connecting arm in a direction perpendicular to an extension direction of the connecting arm; the outer frame sleeve comprises an abutting groove, a rear side wall of the abutting groove forms at least part of the abutting portion, and the hook portion is located in the abutting groove.

4. The optical fiber connector according to claim 3, wherein a first stop protrusion radially protrudes from the outer frame sleeve, and the rear side wall of the abutting groove and part of a front side wall of the first stop protrusion form the abutting portion.

5. The optical fiber connector according to claim 3, wherein a guide portion is provided on the hook portion and is configured to guide the hook portion into the abutting groove, and a side of the guide portion extends forwards and tilts towards an axis of the outer frame sleeve.

6. The optical fiber connector according to claim 2, wherein a sliding groove is provided on an outer periphery of the connector body, a reinforcement protrusion is provided at an end of the connecting arm close to the grip portion, and the reinforcement protrusion is inserted through the sliding groove.

7. The optical fiber connector according to claim 1, wherein at least one of:
a sliding groove is provided on an outer periphery of the connector body, and the connecting portion is slidably inserted through the sliding groove; or
at least four connecting portions are provided, and the at least four connecting portions are disposed around an axis of the connector body.

8. The optical fiber connector according to claim 1, wherein a pull protrusion radially protrudes from the tail frame sleeve.

9. The optical fiber connector according to claim 1, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

10. The optical fiber connector according to claim 2, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

11. The optical fiber connector according to claim 3, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

12. The optical fiber connector according to claim 4, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

13. The optical fiber connector according to claim 5, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

14. The optical fiber connector according to claim 6, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

15. The optical fiber connector according to claim 7, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

16. The optical fiber connector according to claim 8, wherein a second stop protrusion protrudes from the outer periphery of the connector body, a pushing portion is provided on the tail frame sleeve, and the pushing portion is configured to apply force in a direction close to the fitting member to the second stop protrusion when the tail frame sleeve is pushed in a direction close to the inner core.

17. The optical fiber connector according to claim 1, wherein the connector body comprises a front frame sleeve, a middle frame sleeve and a crimp ring, and the front frame sleeve, the middle frame sleeve, and the crimp ring are sequentially connected; and
wherein the inner core is disposed inside the front frame sleeve; or the tail frame sleeve is sleeved on the crimp ring and has a clearance fit with the crimp ring.

18. The optical fiber connector according to claim 2, wherein the connector body comprises a front frame sleeve, a middle frame sleeve and a crimp ring, and the front frame sleeve, the middle frame sleeve, and the crimp ring are sequentially connected; and
wherein the inner core is disposed inside the front frame sleeve; or the tail frame sleeve is sleeved on the crimp ring and has a clearance fit with the crimp ring.

19. The optical fiber connector according to claim 3, wherein the connector body comprises a front frame sleeve, a middle frame sleeve and a crimp ring, and the front frame sleeve, the middle frame sleeve, and the crimp ring are sequentially connected; and
wherein the inner core is disposed inside the front frame sleeve; or the tail frame sleeve is sleeved on the crimp ring and has a clearance fit with the crimp ring.

20. The optical fiber connector according to claim 4, wherein the connector body comprises a front frame sleeve, a middle frame sleeve and a crimp ring, and the front frame sleeve, the middle frame sleeve, and the crimp ring are sequentially connected; and
wherein the inner core is disposed inside the front frame sleeve; or the tail frame sleeve is sleeved on the crimp ring and has a clearance fit with the crimp ring.
